(19) United States
(12) Patent Application Publication
(10) Pub. No.: US 2007/0208621 A1
(43) Pub. Date: Sep. 6, 2007

(54) METHOD OF AND SYSTEM FOR GENERATING LIST USING FLEXIBLE ADJUSTMENT OF ADVERTISING DOMAIN

(75) Inventors: Gyu Tae Park, Gyeonggi-do (KR); Khu Jin Ahn, Seoul (KR); Ji Young Park, Incheon (KR); Min Seon Jeon, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/676,849

(22) Filed: Feb. 20, 2007

(30) Foreign Application Priority Data
Feb. 22, 2006 (KR) 10-2006-0017163

(51) Int. Cl. G06Q 30/00

(52) U.S. Cl. 705/14

(57) ABSTRACT

A method of and system for generating a list using flexible adjustment of an advertising domain, in which the domain size of a display field is determined depending on the number of advertising information to be arranged in each display field so as to create a search result list through flexible adjustment of an advertising domain unlike a conventional method of limiting the number of advertising information to be arranged in each display field so that an item of advertising information is arranged within a predetermined number allocated to each display field. According to the present invention, it is possible to flexibly determine the domain size of a display field within a search result list in view of the number of advertising information to be arranged in the display field.

### CROSS-REFERENCE TO RELATED APPLICATION

This application claims the benefit under 35 U.S.C. §119(a) of Korean Patent Application No. 10-2006-0017163, filed in the Korean Intellectual Property Office on Feb. 22, 2006, the entire disclosure of which is incorporated herein by reference.

### BACKGROUND OF THE INVENTION

1. Field of the Invention

The present invention relates to a method of and system for generating a list using flexible adjustment of an advertising domain, in which the domain size of a display field is determined depending on the number of advertising information to be arranged in each display field so as to create a search result list unlike a conventional method of limiting the number of advertising information to be arranged in each display field so that an item of advertising information is arranged within a predetermined number allocated to each display field.

2. Background of the Related Art

Along with the rapid development of the Internet, information search through a communication network is popularly spread. In a typical Internet information search, when a searcher enters a keyword to be retrieved in a search window of a search web site accessed by the searcher through the communication network, the search web site lists a search result data (i.e., advertising information of an advertiser) for the entered keyword and provides the search result list to the searcher.

In such a search result list providing service, there may occur a significant difference in a searcher exposure frequency to advertising information of an advertiser, an inquiry frequency of the advertiser for a web site visited by the searcher, etc., depending on the position where the advertising information of the advertiser is exposed or displayed within the search result list. Specifically, the exposed position of the advertising information within the search result list has a considerable influence on an advertising effect.

In view of this situation, an operator side of the search web site that provides the search result list to the searcher establishes a domain having a high advertising effect within the search result list as a fee-based advertising domain, and the advertising information is exposed to the searcher through the established advertising domain, so that a given advertising cost is imposed to the advertiser to thereby create a high profitability. Furthermore, the advertiser who is provided with the advertising information-exposing service has an advantageous effect that his or her own advertising information is externally exposed from the position where a high advertising effect can be obtained within the search result list.

However, such a conventional advertising domain entails a problem in that the number of advertising information to be exposed is limited due to a fixed domain size of a display field, and when the number of advertising information to be exposed in a specific advertising domain is plural, some of the plural advertising information is omitted to thereby create the search result list.

This problem results in a fixation of the number of advertising information to be arranged in the display field at an operator side of the search site, thus leading to a limitation in creating advertising profitability and a loss of opportunity of exposing the advertising information at an advertiser side.

Therefore, there is an urgent need for a new type of search result list creating model which can flexibly determine a domain size of a display field within a search result list depending on a number of advertising information to be arranged in the display field to thereby overcome the conventional problems caused due to a fixation of the number of advertising information to be arranged in the display field.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention has been made in view of the aforementioned problems occurring in the conventional art, and it is an object of the present invention to provide a method of and system for generating a list using flexible adjustment of an advertising domain, which flexibly determines a domain size of a display field within a search result list in view of a number of advertising information to be arranged in the display field.

Another object of exemplary embodiments of the present invention is to provide a method of and system for generating a list using flexible adjustment of an advertising domain, which determines a domain size of a display field within a search result list depending on a number of advertising information to be arranged in each display field so as to efficiently utilize the advertising domain, and which creates a search result list capable of externally exposing much more advertising information.

To accomplish the above object, according to one aspect of exemplary embodiments of the present invention, there is provided a method of generating a list using flexible adjustment of an advertising domain, the method comprising the steps: maintaining an advertising information database for storing a plurality of advertising information corresponding to a predetermined keyword; receiving a bid price and information regarding designation of a display field with respect to each of the plurality of advertising information; extracting the plurality of advertising information corresponding to the keyword from the advertising information database and selecting a predetermined number of advertising information among the extracted plurality of advertising information according to a criterion associated with the bid price by the designated display field; determining a domain of each display field depending on the number of the selected advertising information; and arranging the selected advertising information in the each display field having the determined domain, and creating a search result list including the display field associated with the keyword.

To accomplish the above object, according to another aspect of exemplary embodiments of the present invention, there is provided a method of generating a list using flexible adjustment of an advertising domain, the method comprising the steps: maintaining an advertising information database for storing a plurality of advertising information corresponding to a predetermined keyword or an area; receiving a bid price and information regarding designation of a subfield within a display field with respect to each of the plurality of advertising information; extracting the plurality of advertising information corresponding to the keyword and the area from the advertising information database and selecting a predetermined number of advertising information among the extracted plurality of advertising information according to a criterion associated with the bid price by the designated subfield; determining a domain of each subfield within the display field depending on the number of the selected advertising information; and arranging the selected advertising information in the each subfield having the determined domain within the display field, and creating a search result list including the display field associated with the keyword or the area.

### BRIEF DESCRIPTION OF THE DRAWINGS

The above and other objects, features and advantages of the present invention will be apparent from the following detailed description of exemplary embodiments of the invention in conjunction with the accompanying drawings, in which:

FIG. 1 is a block diagram illustrating the construction of a system for generating a list using flexible adjustment of an advertising domain according to an exemplary embodiment of the present invention;

FIG. 2 is a block diagram illustrating the inner construction of a system for generating a list using flexible adjustment of an advertising domain according to an exemplary embodiment of the present invention;

FIG. 3 is a view illustrating an example of an advertising information database according to an exemplary embodiment of the present invention;

FIG. 4 is a view illustrating an example of determining the domain of a display field using flexible adjustment of an advertising domain according to an exemplary embodiment of the present invention;

FIG. 5 is a view illustrating an example of determining the domain of each subfield within a display field using flexible adjustment of an advertising domain according an exemplary embodiment of to the present invention;

FIG. 6 is a flowchart illustrating the process of generating a list using flexible adjustment of an advertising domain according to an exemplary embodiment of the present invention; and

FIG. 7 is a flowchart illustrating the process of generating a list using flexible adjustment of an advertising domain according to another exemplary embodiment of the present invention.

### DETAILED DESCRIPTION OF THE EMBODIMENTS

A method of and system for generating a list using flexible adjustment of an advertising domain according to the present invention will be described hereinafter in detail with reference to the attached drawings.

As used herein, the phrase “flexible adjustment of an advertising domain” may refer to a scheme in which a domain of a display field included in a search result list provided to a searcher in response to a search request of the searcher is flexibly adjusted depending on the number of advertising information to be arranged. Specifically, the flexible adjustment of the advertising domain is intended to solve a conventional advertising information-arranging method in which the number of advertising information to be arranged in a display field (or a subfield within the display field) is limited due to the fixed size of the advertising domain, and when the number of advertising information to be arranged is plural, all the advertising information is not exposed to the searcher. The list generating system of the present invention using flexible adjustment of an advertising domain can create a search result list in which the size of the advertising domain is maximally secured correspondingly to the number of the advertising information to be arranged.

The advertising information arranged in the advertising domain corresponds to one search result item retrieved by a search engine in response to the search request of a searcher who has entered a keyword to be retrieved in a search window of a search site accessed by himself or herself, and may be marketing data for an advertiser or an item dealt with by the advertiser. One item of advertising information, which is brief information for a web site operated by the advertiser, can include for example a title of contents, a summary of contents, a link address, etc.

Specifically, in the exemplary embodiments of the present invention, the advertising information can be associated with both the keyword for retrieval and a specific area, and can be selectively searched depending on the geographical position (or the position inferred from the keyword itself) of a searcher so as to be provided to the searcher.

An advertising information-providing service related to the area allows advertising information of an advertiser to be provided to a searcher having an interest for an area where the business is based, thus having a high possibility that the searcher will be secured as a customer of the advertiser. Such advertising information associated with the area may include, for example, PR information for an advertiser having his or her business basis on a specific area, information on an area item dealt with by the advertiser, purchase price information for the area item, purchase-related event information, etc.

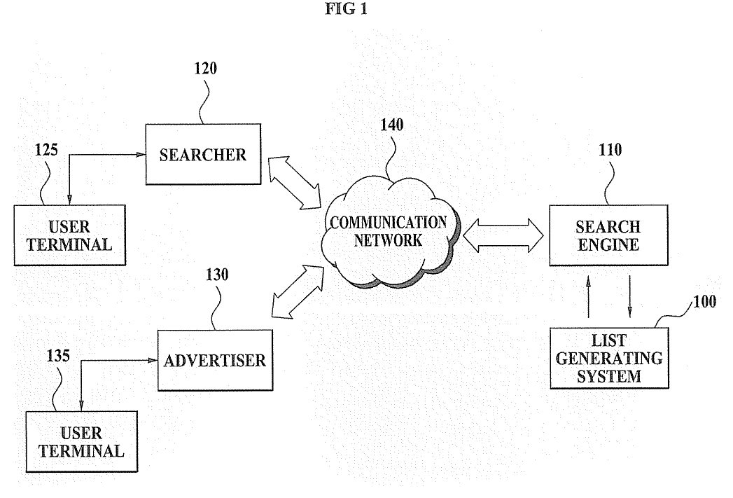

FIG. 1 is a block diagram illustrating the construction of a system for generating a list using flexible adjustment of an advertising domain according to the present invention.

Referring to FIG. 1, the list generating system 100 flexibly adjusts the domain size of a display field within a search result list (or the domain size of a subfield within a display field) provided to a searcher 120 in response to the search request depending on the number of advertising information to be arranged in a corresponding display field or subfield so as to provide an environment which enables creation of a search result list in which no advertising information is omitted.

First, the search engine 110 corresponds to a search program or a search web server that supports a search operation so as to facilitate the access of a searcher 120 to a web site having contents data stored therein. Specifically, the search engine 110 functions to expose advertising information for a contents provider (advertiser) which can provides the contents data requested by the searcher 120 in response to the search request of the searcher 120, and allow the searcher 120 to have an access to a web site of the contents provider (CP) when the searcher 120 clicks on the exposed advertising information so as to smoothly provide the contents data to the searcher 120.

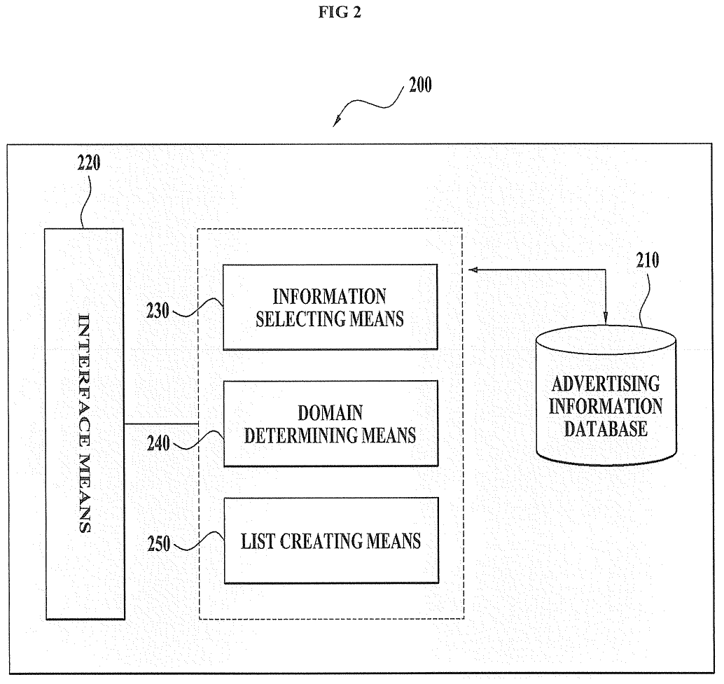

Particularly, in the present exemplary embodiment, when a keyword for retrieval entered by the searcher 120 is associated with an area, the search engine 110 retrieves advertising information corresponding to a specific area from an advertising information database 210, illustrated in FIG. 2, so as to expose the retrieved advertising information to the searcher 120. Specifically, the search engine 110 can allow advertising information of the advertiser 130 associated with the specific area to be exposed to the searcher 120 depending on the entry of the keyword by the searcher 120 so as to provide the advertiser 130 with a search service (local advertising service) permitting a searcher 120 having an interest for an area where the business is based to view advertising information of the advertiser 130. For example, in the case where a keyword for retrieval entered by the searcher 120 is “restaurant, Gangnam-gu, Seoul”, the search engine 110 searches advertising information of advertisers 130 who operate restaurants in Gangnam-gu, Seoul, Republic of Korea so as to expose the searched advertising information to the searcher 120.

In exposure of the advertising information, the search engine 110 identifies the geographical position of the searcher 120 based on a network address such as an IP address, etc., used for the searcher 120 to access the search engine 110, and searches advertising information corresponding to the identified geographical position from the advertising information database 210 so as to expose the retrieved advertising information to the searcher 120. For example, when an IP address “192.168.3.49” is allocated to a searcher 120 located in Gangnam-gu, Seoul, Republic of Korea and the searcher 120 enters a keyword in a search window provided by the search engine 110 using the IP address “192.168.3.49”, the search engine 110 identifies the geographical position of the searcher 120 based on the IP address as “Gangnam-gu, Seoul, Republic of Korea” and retrieves advertising information corresponding to the identified geographical position, i.e., “Gangnam-gu, Seoul, Republic of Korea” from the advertising information database 210 to provide the retrieved advertising information to the searcher 120.

The exposure of the advertising information to the searcher 120 may be performed through a search result list including a plurality of display fields so that the retrieved advertising information is arranged in a display field based on a predetermined criterion (for example, bid price, etc.).

In regard to the display field, the attribute of the advertising service can be determined in consideration of an arrangement position of advertising information within a search result list, a minimum advertising cost assigned, ease for a plurality of searchers to view the advertising information, a click ratio of arranged advertising information by the searcher, among other considerations. For example, a search result list provided as a search result from the Korean portal search site Naver (www.naver.com) includes a sponsored link, a power link, a plus link, a business site, etc., which are a plurality of display fields whose advertising service types are different from one another, and the advertiser 130 can designate the advertising information so that its advertising information is arranged in one or more display fields among the above-mentioned display fields according to a marketing strategy.

The advertising information may include commercial promotional material related to the advertiser 130 or an item dealt with by the advertiser 130, a purchase event, etc., as well as link information for access to a web site operated by the advertiser 130.

As a result, when a searcher 120 who has viewed exposed advertising information clicks on corresponding advertising information, the search engine 110 can induce the searcher 120 who has clicked on the corresponding advertising information to access the web site of the advertiser 130 using the link information.

The searcher 120 has a user terminal 125 used to access the search engine 110, and may correspond to an Internet user who enters a certain keyword in a search window provided by the search engine 110 so as to generate the search request for advertising information to be retrieved, contents data, and a contents provider (CP) having the content data stored therein. In the current embodiment, the searcher 120 enters a keyword related to an area or a keyword for retrieval in a search window provided by the search engine 110 so as to be provided with advertising information of an advertiser having his or her business basis on a corresponding area.

The advertiser 130 may be a service provider who gains access to the search engine 110 or a list generating system 100 of the present invention using the user terminal 135 through the communication network 140, and exposes its advertising information to the searcher 120 depending on the keyword entered by the searcher 120 or the geographical position of the searcher 120 so as to be provided with an advertising information-exposing service. Particularly, in the current embodiment, the advertiser 130 exposes advertising information to a searcher 120 regarded as having an interest for an area having a commercial interest relationship so as to have a high possibility that the searcher 120 will be secured as a customer of the advertiser 130.

The user terminal 125 serves to maintain the access between the searcher 120 and the search engine 110 or the list generating system 100 through the communication network 140 such as the Internet, etc., and to provide various information associated with the advertising information-exposing service to the searcher 120 while displaying the various information on a certain screen.

The list generating system 100 creates a search result list using the flexible adjustment of an advertising domain which flexibly adjusting the domain size of a display field within the search result list (or the domain size of a subfield within a display field) provided to a searcher 120 in response to the search request depending on the number of advertising information to be arranged in a corresponding display field or subfield, thereby preventing some advertising information from being omitted in the search result list to be created due to a deficit of the advertising domain.

Now, the inner construction of a list generating system according to the present invention will be described hereinafter in detail with reference to FIG. 2.

FIG. 2 is a block diagram illustrating an inner construction of a system for generating a list using flexible adjustment of an advertising domain according to an exemplary embodiment of the present invention.

Referring to FIG. 2, the list generating system 200 of the present exemplary embodiment includes an advertising information database 210, an interface means 220, an information selecting means 230, a domain determining means 240, and a list creating means 250. First, the advertising information database 210 stores a plurality of advertising information corresponding to a keyword. Specifically, the advertising information database 210 receives advertising information from the advertiser 130 of FIG. 1 and stores a keyword, which is used as a basis to retrieve the stored advertising information when the search request is generated later, and to provide the retrieved advertising information to the searcher 120, correspondingly to the advertising information. In addition, in another exemplary embodiment of the present invention, the advertising information database 210 can store an area where the business of the advertiser 130 is based corresponding to the advertising information. Thus, the present exemplary embodiment provides a searcher 120 having an interest for a specific area with an environment where the searcher 120 can selectively search advertising information of an advertiser 130 having a commercial interest relationship in a corresponding area.

The interface means 220 receives a bid price and information regarding designation of a display field with respect to each of the plurality of advertising information from the advertiser 130 of the each advertising information.

In this case, the information regarding designation of the display field is information of determining an advertising service attribute of the advertising domain in which the advertising information is exposed. For example, advertising information retrieved based on a keyword (or an area) can be generated by an advertiser 130 considering a position in the search result list exposed to the searcher 120, and the advertiser 130 can select one or more display fields in which his or her advertising information will be arranged among a plurality of display fields to generate the designation information of the display field.

The display field is an advertising domain where the advertising information having the designation information contained therein is arranged based on a predetermined criterion, and each display filed can be allocated with a reference number associated with the number of advertising information to be arranged. For example, a sponsored link i.e., a display field provided by a the Korean portal search site Naver is a display field selected by an advertiser 130 who wants to expose his or her advertising information in the uppermost position of a search result list. When a reference number allocated to the sponsored link is “5”, less than five advertising information can be typically arranged in the sponsored link. In the case of using the flexible adjustment of advertising domain according to and embodiment of the present invention, the number of advertising information to be arranged in the sponsored link can be flexibly adjusted.

The bid price is a maximum advertising cost which can be imposed on the advertiser 130 as the searcher 120 clicks on the exposed advertising information once. In the current embodiment, the bid price can be utilized to determine the order in which advertising information is extracted from the advertising information database or the arrangement position of the advertising information within a display field (or subfield). Typically, the advertising information of the advertiser 130 who has inputted a higher bid price can be arranged in a relatively upper position within a display field. This is aimed at arranging the advertising information in an upper position within the display field so as to provide a greater advertising effect to the advertiser 130 who has paid a higher advertising cost.

Specifically, the interface means 220 serves to receive an intention of the advertiser 130 to participate in the bid so as to arrange advertising information in the display field, and receives, as bid data for the bid participation, a bid price and information regarding designation of a display field with respect to each advertising information. The interface means 220 can receive the information on the bid price and designation of the display field from the advertiser 130 at any time or when the search request is generated. The received information on the bid price and designation of the display field can be recorded to correspond to each advertising information stored in the advertising information database 210.

The information selecting means 230 extracts a plurality of advertising information corresponding to a keyword from the advertising information database 210 and selects a predetermined number of advertising information among the extracted plurality of advertising information according to a criterion associated with the bid price by the designated display field. Specifically, the information selecting means 230 sorts, by a display field, the plurality of advertising information retrieved from the advertising information database 210 corresponding to a specific keyword. In addition, the information selecting means 230 counts the number of the advertising information sorted by a display field to recognize the number of advertising information to be arranged in each display field. In the assortment of the advertising information, the information selecting means 230 can sort the advertising information in consideration of the amount of the advertising cost inputted by the advertiser 30, thereby providing an environment where the advertising information proposed with a higher bid price is preferentially arranged in an optimal position within the display field.

The domain determining means 240 determines a domain of each display field depending on the number of the selected advertising information. Specifically, the domain determining means 240 determines the domain size of each display field within a search result list correspondingly to the number (i.e., the selection number) of the selected advertising information to be actually arranged in the display field. Particularly, in the current embodiment, when a display field (hereinafter, referred to as a “surplus display field”) whose selection number of the selected advertising information is smaller than a predetermined reference number, the domain determining means 240 allows a surplus domain of the surplus display field to be transformed into a domain of another display field so as to completely accomplish the objective of the present invention or the flexible adjustment of an advertising domain.

Specifically, the domain determining means 240 transforms a surplus domain of the surplus display field into a domain of a display field (hereinafter, referred to as a “deficit display field”) whose selection number is larger than a predetermined reference number through the flexible adjustment of an advertising domain, and allows the advertising information to be arranged in the surplus display field.

Accordingly, the domain determining means 240 compares a reference number allocated to a first display field (an arbitrary display field within a search result list) with a selection number associated with the number of advertising information selected with respect to the first display field, and when the reference number exceeds the selection number, calculates a difference between the reference number and the selection number to determine a surplus domain of the first display field. Also, the domain determining means 240 adjusts a domain of a second display field using a total number obtained by adding a reference number of the second display field which is a deficit display field and the calculated difference, so that the surplus domain of the first display field which is a surplus display field can be used as an advertising domain of the second display field which is a deficit display field.

The list creating means 250 arranges the selected advertising information in each display field having the determined domain, and creates a search result list including the display field associated with the keyword. Specifically, the list creating means 250 functions to arrange the advertising information in each display field whose domain size is adjusted depending on the number of advertising information to be arranged to create the search result list. The search result list is a result list provided to the searcher 120 in response to the search request generated by the searcher 120. For example, the search engine 110 can allow a search result corresponding to a keyword included in the list search request to be exposed to the searcher 120 through the user terminal 125.

In the current embodiment, the creation of the search result list corresponding to the keyword is described, however, it is obviously possible to those of ordinary skill in the art to create a search result list concurrently corresponding to an area as well as the keyword. In addition, a point in time when the search result list is created is not specifically limited in the current embodiment, and is possible prior to or after reception of the search request from the searcher 120.

In creation of the search result list, the list creating means 250 can arrange the advertising information designated as being arranged in each display field corresponding to a bid price. Accordingly, the information selecting means 230 sequentially selects a predetermined number of advertising information among a plurality of advertising information extracted from the advertising information database 210 according to the bid price by each display field, and the list creating means 250 can arrange the predetermined number of advertising information in a corresponding display field from the uppermost position within the display field according to the order in which the advertising information is selected. Thus, the advertising domain of the display field included in the created search result list can be adjusted such that the advertising information quoted with a relatively high bid price is arranged an optimal position within the display field to obtain a higher advertising effect.

Moreover, as another example of creating the search result list, the list creating means 250 can sequentially select N number of advertising information designated as being arranged in each display field according to the bid price, and can randomly arrange the selected N number of advertising information in the each display field. Accordingly, the information selecting means 230 can sequentially select N number of advertising information among the plurality of advertising information extracted from the advertising information database 210 by the display field, and the list creating means 250 can randomly arrange the selected N number of advertising information in a corresponding display field irrespective of the order in which the advertising information is selected. As the selected N number of advertising information is randomly arranged in a corresponding display field, the N number of advertising information can obtain an equivalent advertising effect, respectively. In such a random arrangement method, as the searcher 120 clicks on the advertising information, the advertising cost imposed to the advertiser 130 is equally applied to the N number of advertising information by the equivalent advertising effect.

Therefore, according to an exemplary embodiment of present invention, the domain size of a display field can be determined depending on the number of advertising information to be arranged in each display field so as to create a search result list through flexible adjustment of an advertising domain unlike a conventional method of limiting the number of advertising information to be arranged in each display field so that an item of advertising information is arranged within a predetermined reference number allocated to each display field.

Further, according to an exemplary embodiment of the present invention, the domain size of a display field is adjusted depending on the number of advertising information to be arranged in each display field, thereby minimizing a problem in that the advertising information is omitted from the display field of a search result list to be created due to a deficit of the advertising domain.

The flexible adjustment of an advertising domain for a subfield within a display field according to another exemplary embodiment of the present invention will be described hereinafter.

The display field can be composed of a plurality of subfields where the advertising information is arranged depending on an advertising service attribute, and the list generating system 200 can arrange specified advertising information in each subfield.

Specifically, the list generating system 200 can be inputted with a bid price, information regarding designation of a display field, and information regarding designation of a subfield within a display field with respect to advertising information. The list generating system 200 can flexibly determine the domain size of a subfield where the advertising information is arranged with subfield, sorted depending on a predetermined advertising service attribute, according to the number of the advertising information to be arranged in the subfield.

For example, when the display field consists of a subfield where advertising information is arranged which is associated with an area located within a given range from the position of the searcher 120 and a subfield where advertising information of a short distance from the searcher 120 is arranged, the list generating system 200 can determine the advertising information to be arranged in each subfield and can adjust the domain size of each subfield within a display field in consideration of the number of the advertising information determined by a subfield. The designation of a subfield for the advertising information to be arranged can be performed by an operator of the present list generating system considering the position of the searcher 120 who has generated the search request.

In the flexible adjustment of an advertising domain for the subfield, the list generating system 200 compares a reference number allocated to a first subfield (an arbitrary subfield within a display field) with a selection number associated with the number of advertising information selected with respect to the first subfield, and when the reference number exceeds the selection number, recognizes the first subfield as a surplus subfield whose reference number is larger than a selection number. Also, the domain determining means 240 calculates a difference between the reference number and the selection number to recognize a surplus domain of the first subfield and adjusts a domain of a second display field using a total number obtained by adding a reference number of the second subfield which is a deficit display field and the calculated difference, so that the surplus domain of the first subfield which is the surplus subfield can be used as an advertising domain of the second subfield which is the deficit display field.

Therefore, according to an exemplary embodiment of the present invention, the domain size of each subfield can be determined depending on the number of advertising information to be arranged in each subfield so as to create a search result list through flexible adjustment of an advertising domain unlike a conventional method of limiting the number of advertising information to be arranged in each subfield so that an item of advertising information is arranged within a reference number allocated to each subfield within a display field.

Further, according to the present invention, the domain size of a subfield is adjusted according to the number of advertising information to be arranged in each subfield within a display field, thereby minimizing a problem in that the advertising information is omitted from a subfield within the display field of a search result list to be created due to a deficit of the advertising domain.

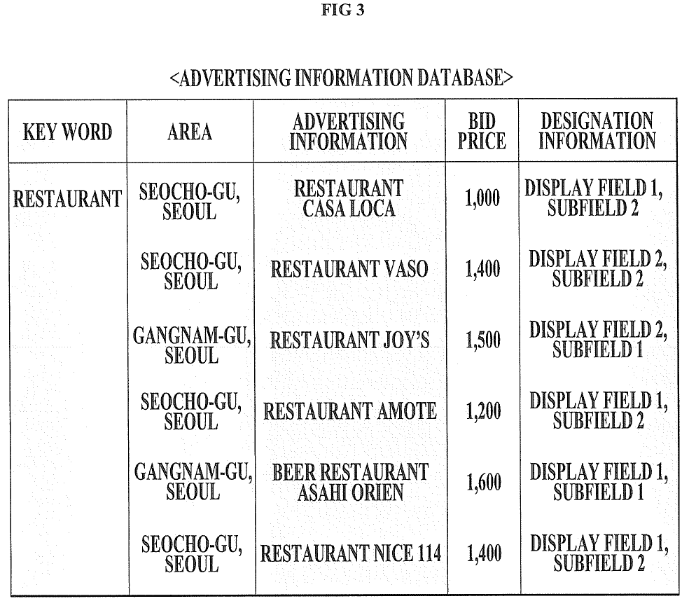

The creation of a search result list using flexible adjustment of advertising domain will be described hereinafter with reference to FIGS. 3 to 5.

FIG. 3 is a view illustrating an example of an advertising information database according to the present invention.

As descried above, the advertising information is promotional information on the advertiser 130 himself or herself or promotional information on an item dealt with by the advertiser, which is written by the advertiser 130. The advertising information is stored in association with a keyword which is used as a basis to extract the advertising information from the advertising information database 210. In addition, when it is desired to search the advertising information of a corresponding area in association with the position of the searcher 120, the advertising information database 210 can allow the keyword and information on the area to concurrently correspond to the advertising information.

Also, the advertising information database 210 can receive a bid price, information regarding designation of a display field, and information regarding designation of a subfield within a display field with respect to the advertising information from the advertiser 130 or the present list generating system, and can record them to correspond to the advertising information, respectively. As described above, the bid price is an advertising cost imposed to the advertiser 130 as the searcher 120 clicks on the advertising information exposed to him or her, and the designation information of the respective display field and subfield may correspond to information of determining an advertising domain for the advertising information to be arranged.

In a state where the advertising information as shown in FIG. 3 is stored in the advertising information database 210, there is exemplified the case where a keyword “restaurant” included in the search request of the searcher 120 is entered, and the position of the searcher 120 who has generated the search request is identified as “Gangnam-gu, Seoul”. The list generating system 200 can extract the advertising information corresponding to the keyword “restaurant” by referring to the advertising information database 210 shown in FIG. 2, and being sorted by a display field. Specifically, the list generating system 200 counts the number of the advertising information selected for display field 1 as “4” including “Restaurant Casa Loca”, and counts the number of the advertising information selected for display field 2 as “4” including “Restaurant VASO”. At this time, the list generating system 200 can sequentially select advertising information in consideration of a bid price, and can provide an environment for the advertising information to be later arranged in a display field correspondingly to the bid price.

Moreover, the list generating system 200 can assort four advertising information including “Restaurant Casa Loca” selected to be arranged in display field 1 into respective subfields within display field 1 in consideration of the geographical position of the searcher 120. Specifically, the list generating system 200 can allow the advertising information “Beer Restaurant Asahi Orien” to be arranged in subfield 1 having the area “Gangnam-gu, Seoul” as an advertising service attribute in consideration of the identified position of the searcher 120, i.e., “Gangnam-gu, Seoul”. Furthermore, the list generating system 200 can allow the three remaining advertising information including “Restaurant Nice 114” to be arranged in subfield 2 having the area “Seocho-gu, Seoul” geographically located at a near distance from the identified position of the searcher 120, i.e., “Gangnam-gu, Seoul” as an advertising service attribute.

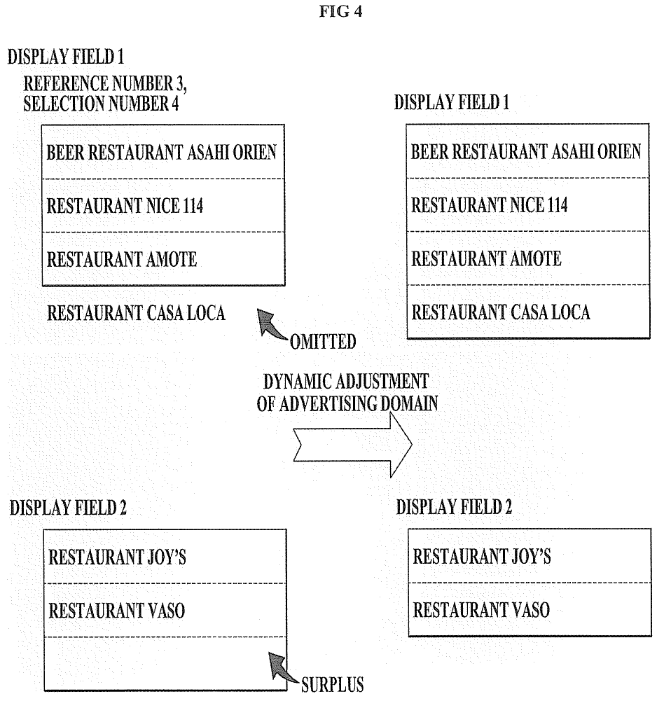

FIG. 4 is a view illustrating an example of determining the domain of a display field using flexible adjustment of an advertising domain according to the present invention.

First, for example, each display field can be allocated with a reference number determined by an operator of the present list generating system, and when the flexible adjustment of an advertising domain according to an exemplary embodiment of the present invention is not performed, advertising information is arranged within a predetermined reference number in the display field. The list generating system 200 of the present invention can perform the flexible adjustment of an advertising domain which flexibly adjusts the domain size of a display field depending on the number (the selection number) of advertising information to be arranged in each display field, so that advertising information whose selection number is greater than or less than the predetermined reference number can be adjusted to be arranged in the display field.

In an example of FIG. 4, when assuming that the number (the selection number) of advertising information selected is “4” with respect to display field 1 allocated with a reference number “3” to arrange three advertising information in display field 1 and the number (the selection number) of advertising information selected is “2” with respect to display field 2 allocated with a reference number “3” to arrange three advertising information in display field 1, the list generating system 200 recognizes display field 1 as a deficit display field where one advertising information is omitted and the display field 2 as a surplus display field where one advertising information is further arranged, respectively. Specifically, display field 1 which is the deficit display field lacks an advertising domain for one item of advertising information to be arranged, and display field 2 which is the surplus display field has an additional advertising domain for one item of advertising information to be arranged.

Under this environment, the list generating system 200 transforms the domain size (surplus advertising domain) corresponding to a difference between the reference number and the selection number with respect to display field 2 into an advertising domain of display field 1 to allow four items of advertising information to be all arranged in display field 1.

In FIG. 4, owing to the flexible adjustment of an advertising domain, the list generating system 200 adjusts the domain size of display field 1 intended for three items of advertising information to be arranged into the domain size enabling arrangement of four items of advertising information by adding the domain size of an advertising domain transformed from display field 2 to the domain size of display field 1. Here, the list generating system 200 adjusts the domain size of display field 2 into the domain size enabling arrangement of two items of advertising information, so that four items of advertising information including the advertising information “Beer Restaurant Asahi Orien” can be arranged in display field 1 according to the order of a bid price and two items of advertising information including the advertising information “Restaurant Joy's” can be arranged in display field 2 according to the order of a bid price. Specifically, the list generating system 200 performs the flexible adjustment of an advertising domain which determines the domain size of a display field depending on the number of advertising information to be arranged in the display field so as to enable creation of a search result list in which no advertising information is omitted.

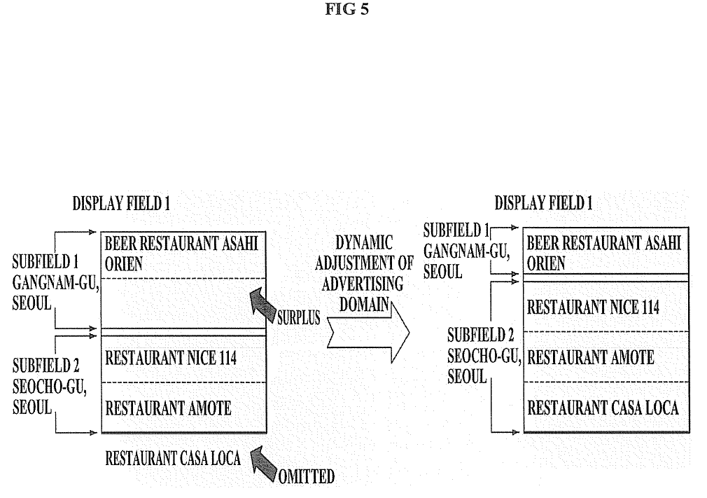

FIG. 5 is a view illustrating an example of determining the domain of each subfield within a display field using flexible adjustment of an advertising domain according to an exemplary embodiment of the present invention.

The display field can be composed of a plurality of subfields depending on an advertising service attribute. For example, each display field can be allocated with a reference number determined by an operator of the present list generating system. As described above, the reference number is associated with the number of advertising information which can be arranged in a subfield, and the domain size of the subfield can be flexibly adjusted by the flexible adjustment of an advertising domain according to the present invention. Thus, the number of advertising information to be substantially arranged in each subfield advertising information can be adjusted so that advertising information whose selection number is greater than or less than the predetermined reference number is arranged in the subfield.

Through the examples shown in FIGS. 3 and 4, display field 1 determined as four items of advertising information being arranged can be composed of subfield 1 and subfield 2 in view of a relationship between the area and the identified position of the searcher 120. For example, display field 1 in FIG. 5 is composed of subfield 1 intended to arrange the advertising information associated with the area located within a certain range from the position of the searcher 120 who generates the search request, and subfield 2 intended to arrange the advertising information associated with the area located within another certain distance from the position of the searcher 120. When the position of the searcher 120 who has generated the search request is identified as “Gangnam-gu, Seoul”, the list generating system 200 selects one item of advertising information associated with the area “Gangnam-gu, Seoul” so as to be arranged in subfield 1, and selects three items of advertising information associated with “Seocho-gu, Seoul” geographically located at a distance relatively close to the area “Gangnam-gu, Seoul” so as to be arranged in subfield 2.

At this time, when a reference number allocated to the respective subfields 1 and 2 is “2” enabling arrangement of two items of advertising information only, the list generating system 200 recognizes subfield 1 as a surplus display field where one advertising information can be arranged further since the selection number of the subfield 1 is smaller than the reference number by “1”, and subfield 2 as a deficit display field where one advertising information is omitted since the selection number of subfield 2 is larger than the reference number by “1”. Under this environment, the list generating system 200 transforms the domain size (surplus advertising domain) corresponding to a difference between the reference number and the selection number with respect to subfield 1 into an advertising domain of subfield 2 so as to allow three items of advertising information selected to be all arranged in subfield 2.

In FIG. 5, due to the flexible adjustment of advertising domain, the list generating system 200 adjusts the domain size of subfield 2 intended for two items of advertising information to be arranged into the domain size enabling arrangement of three items of advertising information by adding the domain size of an advertising domain transformed from subfield 1 to the domain size of subfield 2. At this time, the list generating system 200 adjusts the domain size of subfield 1 into the domain size enabling arrangement of one item of advertising information, so that one item of advertising information “Beer Restaurant Asahi Orien” located at the area “Gangnam-gu, Seoul” which is identical to the position of the searcher 120 can be arranged in subfield 1 and three items of advertising information including the advertising information “Restaurant Nice 114” can be randomly arranged in subfield 2 in an arbitrary order. Specifically, the list generating system 200 performs the flexible adjustment of an advertising domain which determines the domain size of a subfield depending on the number of advertising information to be arranged in the subfield so as to enable creation of a search result list in which no advertising information is omitted.

Therefore, according to the present invention, the domain size of a display field included in a search result list, or the domain size of a subfield within the display field can be flexibly adjusted to correspond to the number of advertising information to be arranged in the display field or the subfield.

Also, according to an exemplary embodiment of the present invention, it is possible to minimize a conventional demerit in which there occurs an advertising domain where the advertising information is omitted or is not arranged and is surplus as well as the advertising domain is utilized inefficiently as the number of advertising information to be arranged is fixed due to a restriction of the domain size.

Now, the operational process of a system for generating a list using flexible adjustment of an advertising domain according to an exemplary embodiment of the present invention will be described.

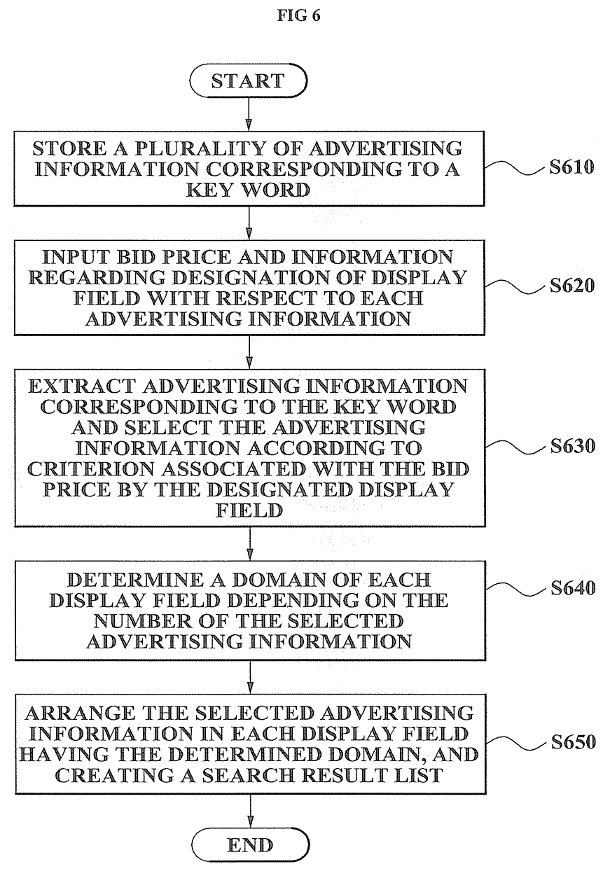

FIG. 6 is a flowchart illustrating the process of generating a list using flexible adjustment of an advertising domain according to an exemplary embodiment of the present invention.

The list generating method of the present invention can be conducted by the above-mentioned list generating system 200.

First, in operation S610, the list generating system 200 maintains an advertising information database 210 for storing a plurality of advertising information corresponding to a predetermined keyword. Operation S610 is a step of storing advertising information which is a marketing data for an advertiser 130 or an item dealt with by the advertiser 130 corresponding to the key work. The keyword corresponds to a keyword for retrieval associated with an advertiser or an item as a to-be-advertised object, and can be flexibly selected by the advertiser 130 considering a marketing strategy.

Further, in operation S620, the list generating system 200 is inputted with a bid price and information regarding designation of a display field with respect to each of the plural advertising information. Operation S620 is a step of receiving, from the advertiser 130, bid information associated with the position of the advertising information within a search result list in which advertising information is exposed. The designation information of the display field is used to determine an advertising service attribute. For example, the advertising information can be arranged in the form of a text and an image for an advertiser 130 generating the designation information for a display field “Pluspro” provided by the Korean portal search site “Naver”. Also, the bid price is an advertising cost imposed to an advertiser 130 as the searcher 120 clicks on the advertising information exposed to him or her. The bid price can be utilized as a criterion for determining the order in which the advertising information retrieved from the advertising information database 210 is assorted by a display field, or determining the arrangement position of the advertising information within the display field.

Next, in operation S630, the list generating system 200 extracts the plurality of advertising information corresponding to the keyword from the advertising information database 210 and selects a predetermined number of advertising information among the extracted advertising information according to a criterion associated with the bid price by the designated display field. Operation S630 is a step of sorting the advertising information retrieved corresponding to the predetermined keyword in consideration of the bid price and the display field. Specifically, in operation S630, the list generating system 200 sequentially selects the advertising information quoted with a relatively high bid price by each display field so as to provide an environment enabling the counting of the number of advertising information to be arranged in each display field. The keyword the search request is associated with a keyword for retrieval generating the search request, but operation S630 is allowable at any point in time prior to or after reception of the search request from the searcher 120.

In addition, in operation S640, the list generating system 200 determines a domain of each display field depending on the number of the selected advertising information. Operation S640 is a step of performing the flexible adjustment of advertising domain which compares a predetermined reference number allocated in association with the number of advertising information to be arranged in a display field with the number (selection number) of advertising information selected with respect to a corresponding display field at the previous operation S630, and flexibly adjusts the domain size of the display field according to a result of the comparison.

In the flexible adjustment process of an advertising domain, the list generating system 200 compares a reference number allocated to an arbitrary first display field with a selection number associated with the number of advertising information selected with respect to the first display field, and when the reference number exceeds the selection number, calculates a difference between the reference number and the selection number.

Specifically, the list generating system 200 identifies a surplus advertising domain in the first display field which is a surplus display field.

Next, the list generating system 200 adjusts a domain of a second display field using a total number obtained by adding a reference number of the second display field which is a deficit display field whose selection number exceeds the reference number and the calculated difference.

Therefore, the list generating system 200 can completely perform the flexible adjustment of an advertising domain in which a surplus advertising domain of the surplus display field can be utilized in the deficit display field.

Subsequently, in operation S650, the list generating system 200 arranges the selected advertising information in the each display field having the determined domain, and creates a search result list including the display field associated with the keyword. Operation S650 is a step of arranging the selected advertising information in the each display field having the domain determined according to the flexible adjustment of an advertising domain, and creating a search result list including the display field. In the process of creating the search result list, the list generating system 200 allows the arrangement of advertising information within the display field to be sequentially conducted from the uppermost position of the display field in the order of the bid price so as to provide the advertiser with an advertising effect corresponding to the advertising cost to be paid. Further, in another arrangement method of the advertising information within the display field, the list generating system 200 allows the selected advertising information to be randomly arranged in a corresponding display field regardless of the order of the bid price so as to obtain an equivalent advertising effect obtainable within a specific display field with respect to all the advertising information.

Next, the list generating system 200 provides a search result list corresponding to a keyword for retrieval and subjected to the flexible adjustment of an advertising domain to the searcher 120 in response to the search request of the searcher 120 including the keyword.

Thus, according to the present invention, the domain size of a display field can be determined depending on the number of advertising information to be arranged in each display field so as to create a search result list through flexible adjustment of an advertising domain unlike a conventional method of limiting the number of advertising information to be arranged in each display field so that an item of advertising information is arranged within a predetermined reference number allocated to each display field.

In addition, according to the present invention, the domain size of a display field is adjusted depending on the number of advertising information to be arranged in each display field, thereby minimizing a problem where the advertising information is omitted from the display field of a search result list to be created due to a deficit of the advertising domain.

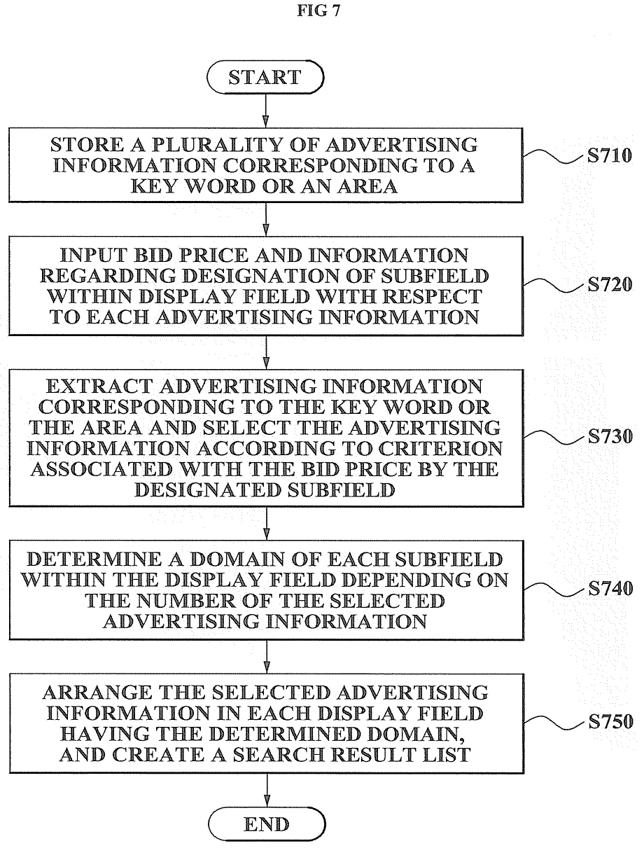

FIG. 7 is a flowchart illustrating the process of generating a list using flexible adjustment of an advertising domain according to another exemplary embodiment of the present invention.

First, in operation S710, the list generating system 200 maintains an advertising information database 210 for storing a plurality of advertising information corresponding to a predetermined keyword or area. Operation S710 is a step of storing advertising information which is a marketing data for an advertiser 130 having a business basis on a specific area or an item dealt with by the advertiser 130 correspondingly to the key work or area. The keyword and the area can be flexibly selected by the advertiser 130 considering a marketing strategy.

Further, in operation S720, a bid price and information regarding designation of a subfield within a display field with respect to each of the plural advertising information is inputted into the list generating system 200. Operation S720 is a step of receiving information regarding the advertising cost from the advertiser 130, identify the position of the searcher 120 who has generated the search request, and generating the designation information of the subfield with respect to each advertising information in consideration of a relationship between the area and the identified position of the searcher. For example, in the case where the display field is composed of subfield 1 intended to arrange the advertising information associated with the area located within a certain range from the position of the searcher 120 who generates the search request, and subfield 2 intended to arrange the advertising information associated with the area located at another certain distance from the position of the searcher 120, the list generating system 200 can input the designation information of the subfield using each advertising information of the advertising information database 210 in view of the identified position of the searcher 120.

Next, in operation S730, the list generating system 200 extracts the plurality of advertising information corresponding to the keyword or area from the advertising information database 210 and selects a predetermined number of advertising information among the extracted advertising information according to a criterion associated with the bid price by the designated subfield. Operation S730 is a step of sorting the advertising information retrieved corresponding to the predetermined keyword or area in consideration of the bid price and the subfield. Specifically, in operation S730, the list generating system 200 sequentially selects the advertising information quoted with a relatively high bid price by each display field so as to provide an environment enabling the counting of the number of advertising information to be arranged in each display field.

In addition, in operation S740, the list generating system 200 determines a domain of each subfield within the display field depending on the number of the selected advertising information. Operation S740 is a step of performing the flexible adjustment of advertising domain which compares a predetermined reference number allocated in association with the number of advertising information to be arranged in each subfield within a display field with the number (selection number) of advertising information selected with respect to a corresponding subfield at the previous operation S730, and flexibly adjusts the domain size of the subfield according to a result of the comparison.

In the flexible adjustment process of an advertising domain, the list generating system 200 compares a reference number allocated to an arbitrary first subfield within the display field with a selection number associated with the number of advertising information selected with respect to the first subfield, and when the reference number exceeds the selection number, calculates a difference between the reference number and the selection number. Specifically, the list generating system 200 identifies a surplus advertising domain in the first subfield which is a surplus display field.

Next, the list generating system 200 adjusts a domain of a second subfield using a total number obtained by adding a reference number of the second subfield which is a deficit subfield whose selection number exceeds the reference number and the calculated difference.

Therefore, the list generating system 200 can completely perform the flexible adjustment of an advertising domain in which a surplus advertising domain of the surplus subfield can be utilized in the deficit display field.

Subsequently, in operation S750, the list generating system 200 arranges the selected advertising information in the each subfield having the determined domain within the display field, and creates a search result list including the display field associated with the keyword or area. Operation S750 is a step of arranging the selected advertising information in the each subfield having the domain determined according to the flexible adjustment of an advertising domain, and creating a search result list including the display field constituting the subfield where the advertising information is arranged. In the process of creating the search result list, the list generating system 200 allows the arrangement of advertising information within the subfield to be sequentially conducted from the uppermost position of the subfield in the order of the bid price so as to provide the advertiser with an advertising effect corresponding to the advertising cost to be paid. Further, in another arrangement method of the advertising information within the display field, the list generating system 200 allows the selected advertising information to be randomly arranged in a specific subfield in an arbitrary order regardless of the order of the bid price so as to obtain an equivalent advertising effect obtainable within a specific subfield with respect to all the advertising information.

Next, the list generating system 200 provides a search result list corresponding to a keyword for retrieval or an area and subjected to the flexible adjustment of an advertising domain to the searcher 120 in response to the search request of the searcher 120 including the keyword or the area.

Thus, according to the present invention, the domain size of a subfield can be determined depending on the number of advertising information to be arranged in each subfield so as to create a search result list through flexible adjustment of an advertising domain unlike a conventional method of limiting the number of advertising information to be arranged in each subfield so that an item of advertising information is arranged within a predetermined reference number allocated to each subfield.

In addition, according to the present invention, the domain size of a subfield is adjusted depending on the number of advertising information to be arranged in each subfield within the display field, thereby minimizing a problem where the advertising information is omitted from the subfield of a search result list to be created due to a deficit of the advertising domain

The above-mentioned embodiments according to the present invention may include a computer-readable recording medium storing therein a program command for executing the operation implemented in various computers. The computer-readable recording medium may include program commands, data files, data structures, or the like alone or a combination thereof. The program commands of the computer-readable recording medium may be ones designed and configured specially for the sake of the present invention, or ones that are well-known to and can be used by those skilled in the art. Examples of the computer-readable recording medium include magnetic media such as hard disks, floppy disks and magnetic tapes, optical media such as CD-ROMs, DVD, etc., magneto-optical media, and hardware devices such as ROMs, RAMs, flash memories, etc., that are configured specially store and execute program commands. Also, the computer-readable recording medium may include transmission media of light or metal wires, wave guides, etc., including carrier waves that transmit a signal for designating the program commands, data structures, etc. Examples of the program commands include machine language codes as construed by a compiler as well as high-level language codes executable by a computer using interpreters, etc.

As apparent from the foregoing, according to a method of and system for generating a list using flexible adjustment of an advertising domain of the present invention, it is possible to flexibly determine a domain size of a display field within a search result list in view of a number of advertising information to be arranged in the display field.

Furthermore, it is possible to determine a domain size of a display field within a search result list depending on a number of advertising information to be arranged in each display field so as to efficiently utilize the advertising domain, and which create a search result list capable of externally exposing much more advertising information.

While the present invention has been described with reference to the particular illustrative exemplary embodiments, it is not to be restricted by the exemplary embodiments but only by the appended claims. It is to be appreciated that those skilled in the art can change or modify the exemplary embodiments without departing from the scope and spirit of the present invention.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. A method of generating a list using flexible adjustment of an advertising domain, the method comprising the steps:
maintaining an advertising information database for storing a plurality of advertising information corresponding to at least one predetermined keyword;
receiving bid data corresponding to at least one advertising display field among a plurality of advertising display fields from advertisers, the bid data including advertising information;
storing said bid data in said advertising information database;
retrieving at least a portion of said stored advertising information in response to a search request including a search keyword;
selecting a predetermined number of advertising information among the retrieved advertising information in association with said search keyword according to a criterion associated with the bid price by the designated display field;
determining the size of each display field depending on the number of the selected advertising information;
arranging the selected advertising information in the each display field having the resized display field: and
creating a search result list including the display field associated with the keyword.

2. The method of claim 1, wherein each of the display fields is allocated with a reference number associated with the number of advertising information to be arranged,
wherein the step of determining the size of each display field further comprises:
comparing a reference number allocated to a first display field with a selection number associated with the number of advertising information selected with respect to the first display field;
calculating a difference between the reference number and the selection number when the reference number exceeds the selection number; and
adjusting the size of a second display field using a total number obtained by adding a reference number of the second display field and the calculated difference.

3. The method of claim 2, wherein the second display field is a display field of which the selection number exceeds the reference number.

4. The method of claim 1, wherein the step of selecting a predetermined number of advertising information further comprises a step of sequentially selecting the predetermined number of advertising information according to the bid price by the designated display field,
wherein the steps of creating a search result list further comprises a step of arranging the selected advertising information in the each display field according to the order in which the advertising information is selected.

5. The method of claim 1, wherein the step of selecting a predetermined number of advertising information further comprises a step sequentially selecting N number of advertising information according to the bid price by the designated display field,
wherein the steps of creating a search result list further comprises a step of randomly arranging the selected N number of advertising information in the each display field.

6. A computer-readable recording medium having a program stored therein for implementing executing the method recited in claim 1.

7. A method of generating a list using flexible adjustment of an advertising domain, the method comprising the steps:
maintaining an advertising information database for storing a plurality of advertising information corresponding to at least one predetermined keyword;
receiving bid data corresponding to at least one subfield within an advertising display field among a plurality of advertising display fields from advertisers, the bid data including advertising information;
storing said bid data in said advertising information database;
retrieving at least a portion of said stored advertising information in response to a search request including a search keyword, the retrieved advertising information being associated with said search keyword, the search request being associated with a subfield of the retrieved advertising information;
selecting a predetermined number of advertising information among the retrieved advertising information according to a criterion associated with the bid price by the designated subfield;
determining the size of each display field depending on the number of the selected advertising information;
arranging the selected advertising information in the each subfield having the resized the display field; and
creating a search result list including the display field associated with the keyword or the area.

8. The method of claim 7, wherein the step of receiving bid data corresponding to at least one subfield within an advertising display field among a plurality of advertising display fields from advertisers further comprises:
identifying the position of a searcher who has generated a search request; and
determining each subfield within the display field for the advertising information to be arranged in consideration of a relationship between the area and the identified position of the searcher.

9. The method of claim 8, wherein the each subfield is allocated with a reference number associated with the number of advertising information to be arranged,
wherein the step of determining the size of each display field further comprises:
comparing a reference number allocated to a first subfield with a selection number associated with the number of advertising information selected with respect to the first subfield;
calculating a difference between the reference number and the selection number when the reference number exceeds the selection number; and
adjusting the size of a second subfield using a total number obtained by adding a reference number of the second subfield and the calculated difference.

10. The method of claim 9, wherein the second subfield is a subfield of the display field of which the selection number exceeds the reference number.

11. The method of claim 7, wherein the step of selecting a predetermined number of advertising information further comprises a step of sequentially selecting the predetermined number of advertising information according to the bid price by the designated subfield,
wherein the steps of creating a search result list further comprises a step of arranging the selected advertising information in the each subfield within the display field according to the order in which the advertising information is selected

12. The method of claim 7, wherein the step of selecting a predetermined number of advertising information further comprises a step sequentially selecting N number of advertising information according to the bid price by the designated subfield,
wherein the steps of creating a search result list further comprises a step of randomly arranging the selected N number of advertising information in the each subfield within the display field in an arbitrary order.

13. A computer-readable recording medium having a program stored therein for implementing executing the method recited in claim 7.

14. A system for generating a list using flexible adjustment of an advertising domain, the system comprising:
an advertising information database for storing a plurality of advertising information corresponding to a predetermined keyword;
an interface means for receiving a bid price and information regarding designation of a display field with respect to each of the plurality of advertising information;
an information selecting means for extracting the plurality of advertising information corresponding to the keyword from the advertising information database and selecting a predetermined number of advertising information among the extracted plurality of advertising information according to a criterion associated with the bid price by the designated display field;
a domain determining means for determining the size of each display field depending on the number of the selected advertising information; and
a list creating means for arranging the selected advertising information in the each display field having the determined size, and creating a search result list including the display field associated with the keyword.

15. The system of claim 14, wherein the each display filed is allocated with a reference number associated with the number of advertising information to be arranged, and wherein the domain determining means
(a) compares a reference number allocated to a first display field with a selection number associated with the number of advertising information selected with respect to the first display field,
(b) calculates a difference between the reference number and the selection number when the reference number exceeds the selection number, and
(c) adjusts the size of a second display field using a total number obtained by adding a reference number of the second display field and the calculated difference.

16. The method of claim 14, wherein the information selecting means sequentially selects the predetermined number of advertising information according to the bid price by the designated display field,
wherein the list creating means arranges the selected advertising information in the each display field according to the order in which the advertising information is selected.

17. The method of claim 14, wherein the information selecting means sequentially selects N number of advertising information according to the bid price by the designated display field,
wherein the list creating means randomly arranges the selected N number of advertising information in the each display field.
